(19) United States
(12) Patent Application Publication
(10) Pub. No.: US 2006/0000104 A1
(43) Pub. Date: Jan. 5, 2006

(54) Tubular measuring device

(76) Inventor: Ryan A. Patton, Bowling Green, OH (US)

Correspondence Address: FRASER MARTIN BUCHANAN MILLER LLC, 132C WEST SECOND STREET, PERRYSBURG, OH, 43551-1401, US

(21) Appl. No.: 11/174,987

(22) Filed: Jul. 5, 2005

Related U.S. Application Data
(60) Provisional application No. 60/585,325, filed on Jul. 2, 2004.

(51) Int. Cl. G01B 3/10

(52) U.S. Cl. 33/755

(57) ABSTRACT

A tubular measuring device is disclosed having measuring indicia disposed on an outer surface thereof, wherein the measuring device is bendable to facilitate obtaining a measurement of a distance having a complex and an irregular shape and an efficiency in the measuring thereof is maximized.

### CROSS-REFERENCE TO RELATED APPLICATION

This application claims priority to U.S. provisional application No. 60/585,325, filed Jul. 2, 2004.

### FIELD OF THE INVENTION

The present invention relates to a measuring device and more particularly to a tubular measuring device having measuring indicia disposed on an outer surface thereof, wherein the measuring device is bendable.

### BACKGROUND OF THE INVENTION

Typically, measurement of a distance necessitates the use of a standard tape measure, wherein a linear distance can be measured. However, measurement of distances involving curves, corners, changes in elevation, and the like is difficult using a conventional distance measuring device, resulting in inaccuracies in the measured distance.

In gardening and landscaping, for example, it is often desirable to obtain length measurements to determine a total length or quantity of materials required for a particular task. For edging material, fencing, and the like, a distance around the area to be contained must be obtained in order to determine the total length of material required. For landscaping blocks and other individual building elements, a total distance where the elements are to be placed must be obtained. A total length can then be determined by dividing the total distance by an individual element length to determine the total number of elements required.

The measurements required in gardening and landscaping are typically complex and curvilinear in nature. These measurements are difficult to obtain using conventional distance measuring devices resulting in measurements which are not precise and may require estimating in some cases. This results in wasted time and materials. Additionally, conventional measuring devices are stored at a point away from the area being gardened or landscaped and requiring measurement.

It would be desirable to produce a tubular measuring device having measuring indicia disposed on an outer surface thereof, wherein obtaining measurements of complex shapes is facilitated and an efficiency of a measuring task is maximized.

### SUMMARY OF THE INVENTION

Consistent and consonant with the present invention, a tubular measuring device having measuring indicia disposed on an outer surface thereof, wherein obtaining measurements of complex shapes is facilitated and an efficiency of a measuring task is maximized, has surprisingly been discovered.

In one embodiment, the measuring device comprises an elongate flexible main body having a first open end, a second open end, an outer surface, and a hollow interior; and measuring indicia disposed on at least a part of the outer surface of the main body between the first end and the second end thereof.

In another embodiment, the measuring device comprises an elongate flexible main body having a first open end, a second open end, an outer surface, and a hollow interior, wherein the main body is adapted to have an elongate member inserted therein extending from the first end to the second end of the main body; and measuring indicia disposed on at least a part of the outer surface of the main body between the first end and the second end thereof.

In another embodiment, the measuring device comprises an elongate flexible main body having a first end, a second end, an outer surface, a hollow interior, and a separation formed in the outer surface extending from the first end to the second end, wherein the main body is adapted to have an elongate member disposed therein extending from the first end to the second end of the main body; and measuring indicia disposed on at least a part of the outer surface of the main body between the first end and the second end thereof.

### BRIEF DESCRIPTION OF THE DRAWING

The above, as well as other advantages of the present invention, will become readily apparent to those skilled in the art from the following detailed description of a preferred embodiment when considered in the light of the accompanying drawings in which:

FIG. 1 is a perspective view of a tubular measuring device according to an embodiment of the invention;

FIG. 2 is a perspective view of a tubular measuring device according to another embodiment of the invention; and

FIG. 3 is a perspective view of a tubular measuring device according to another embodiment of the invention.

### DETAILED DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

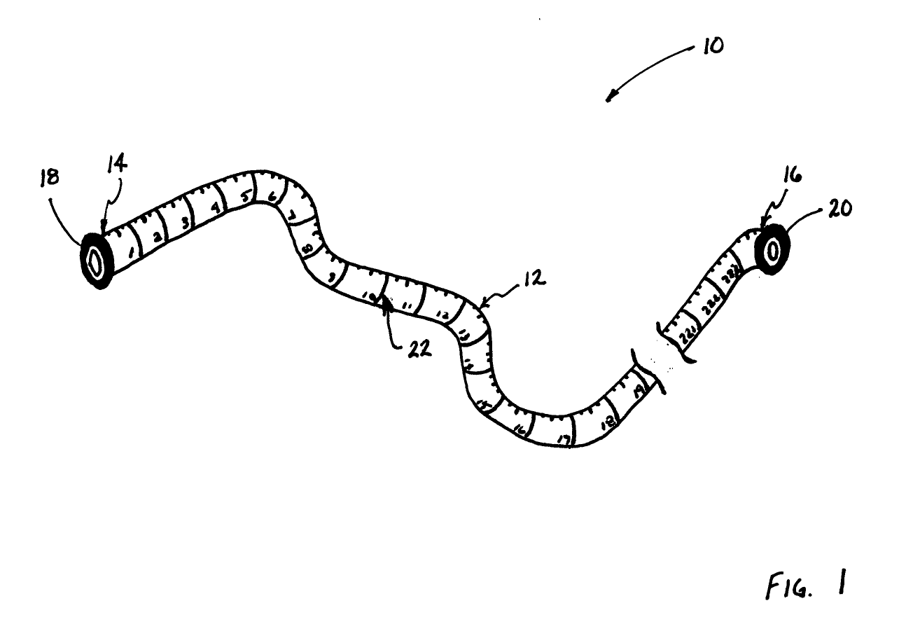

FIG. 1 depicts a tubular measuring device 10 according to an embodiment of the invention. The tubular measuring device 10 includes a hollow elongate main body 12. Any conventional hollow tubular device such as a hose, for example, can be used to form the main body 12. The main body 12 is flexible to permit a bending thereof along a longitudinal axis into arcs, curves, circles, pre-determined patterns, and other complex shapes, for example. Any conventional flexible material can be used to produce the main body 12 such as a plastic, a fabric, a lined fabric, or a reinforced flexible material, for example. In the embodiment shown, the main body 12 is shown as opaque. However, it is understood that at least a part of the main body 12 can be produced from a transparent or a semi-transparent material to permit viewing of the contents of the tubular measuring device 10.

The main body 12 includes a first end 14 and a spaced apart second end 16. In the embodiment shown, the first end 14 includes a fitting 18 and the second end 16 includes a fitting 20 disposed thereon. The fittings 18, 20 can be any conventional fitting such as a male and a female hose coupling, for example. The fittings 18, 20 are adapted to be connected to various devices such as a source of pressurized fluid (not shown) and an outlet nozzle, for example. It is understood that other types of fittings 18, 20 can be used, or that the tubular measuring device 10 can be used without fittings 18, 20 as desired, without departing from the scope and spirit of the invention.

An outer surface of the main body 12 includes measuring indicia 22 formed thereon. The indicia 22 can include markings for measurement of a length between points and a volume of fluid contained in the measuring device 10, for example. It is understood that more than one set of indicia 22 can be provided such as that indicating the length between points and the volume of fluid contained in the measuring device 10. The indicia 22 illustrated commences at the first end 14 adjacent the fitting 18 and ends at the second end 16 adjacent the fitting 20, although the indicia 22 can appear on only a part of the main body 12, if desired.

In use, the measuring device 10 can be stored either coiled or spooled on a reel, for example. When it is desired to take a measurement, the measuring device 10 is uncoiled or de-spooled. The first end 14 of the main body 12 is placed at a desired starting point (not shown) representing one end of the distance to be measured. The main body 12 is then positioned as desired to represent the shape or contour to be measured, and a total length of the shape or contour being measured is obtained by reading from the indicia 22 at a desired ending point (not shown). For example, if the measuring device 10 is being used to measure a total length for landscaping block around a house, the first end 14 of the main body 12 is positioned at one end of the contour where the landscaping block will be positioned. The main body 12 is then positioned on the ground along a desired path of the landscaping block. Once a desired ending point of the contour is reached, a reading from the indicia 22 is obtained to provide the total distance from the starting point to the ending point of the contour. When used in this fashion, accurate measurements can be obtained around a tree, around a corner of a house, or in any desired linear or non-linear shape, for example. When the desired measurements have been obtained, the measuring device 10 can then be recoiled or re-spooled for storage.

As can be appreciated, the tubular measuring device 10 is well suited for a garden hose, for example. The garden hose is typically stored in and around gardens and decorative landscaping and is easily accessible and available for use. The user is not required to obtain a measuring device from a location remote from the area where the task is to be performed. Additionally, the flexibility of the garden hose facilitates taking accurate measurements along both a linear and non-linear contour as desired. The use of the garden hose as the tubular measuring device 10 maximizes a task efficiency by allowing a dual use as fluid conveying device and the measuring device 10. When used in this manner, the main body 12 is substantially fluid tight to militate against leaks.

The garden hose described herein and shown in the drawings is meant to be exemplary. It is understood that other shapes and configurations such as a flexible cord or other flexible member, for example, can be used without departing from the scope and spirit of the invention.

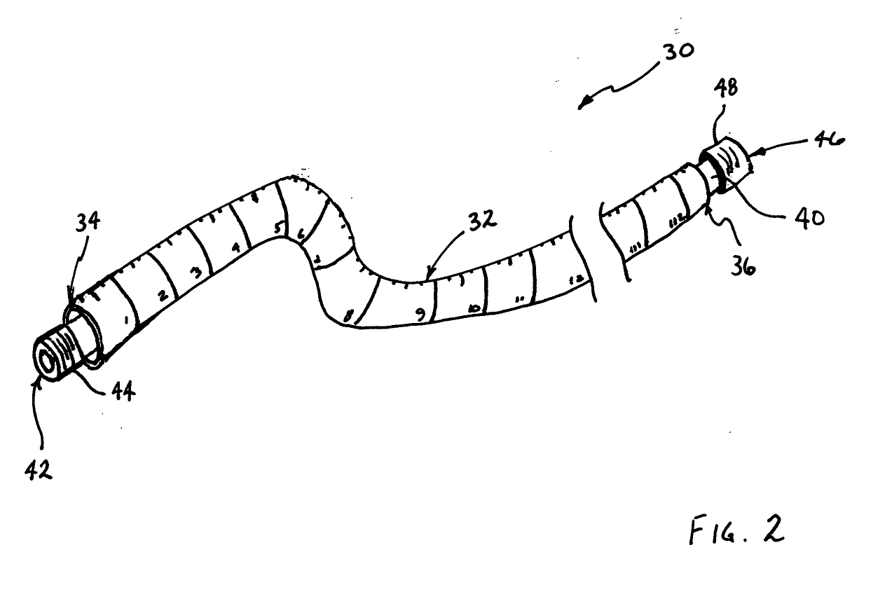

FIG. 2 shows a tubular measuring device 30 according to another embodiment of the invention. The tubular measuring device 30 includes a hollow elongate main body 32. Any conventional hollow tubular device such as a hose, for example, can be used to form the main body 32. The main body 32 is flexible to permit a bending thereof along a longitudinal axis into arcs, curves, circles, pre-determined patterns, and other complex shapes, for example. Any conventional flexible material can be used to produce the main body 32 such as a plastic, a fabric, a lined fabric, or a reinforced flexible material, for example. The main body 32 includes a first end 34 and a spaced apart second end 36.

An outer surface of the main body 32 includes measuring indicia 38 formed thereon. The indicia 38 can include any increment, as desired. It is also understood that more than one set of indicia 38 can be provided on the measuring device 30, as desired. The indicia 38 illustrated commences at the first end 34 of the main body 32 and ends at the second end 36 of the main body 32.

The main body 32 is adapted to be disposed around an elongate member 40. In the embodiment shown, the elongate member 40 is a hose, although it is understood that the elongate member 40 can be any conventional solid or tubular elongate member, as desired. Additionally, although a gap is shown between the main body 32 and the elongate member 40, it is understood that the gap could be eliminated to facilitate a close fit between the main body 32 and the elongate member 40, or that the main body 32 can be adhered to the elongate member 40. The elongate member 40 includes a first end 42 having a fitting 44 and a second end 46 having a fitting 48 disposed thereon. The fittings 44, 48 can be any conventional fitting such as a male and a female hose coupling, for example.

In use, the measuring device 30 is disposed around the elongate member 40. This facilitates the conversion of a conventional elongate member 40 such as a hose, for example, into a flexible measuring device. Once disposed around the elongate member 40, the tubular measuring device 30 is used as described above for the tubular measuring device 10.

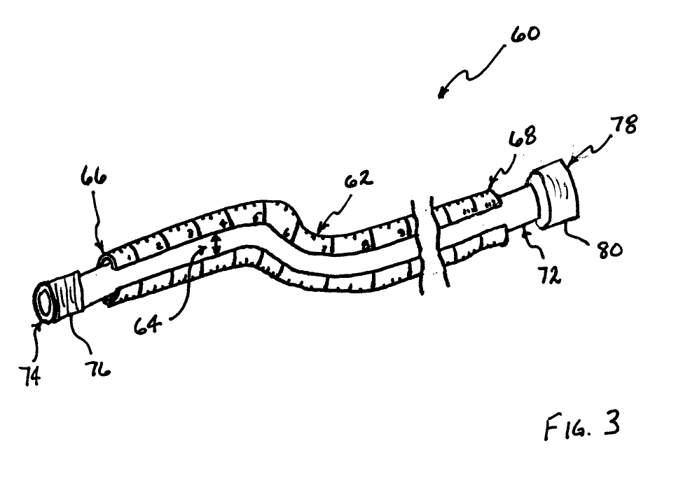

FIG. 3 illustrates a tubular measuring device 60 according to another embodiment of the invention. The tubular measuring device 60 includes an elongate main body 62. The main body 62 includes an elongate separation 64 formed therein. Any conventional hollow tubular device such as a hose, for example, can be used to form the main body 62. Additionally, an elongate flat sheet can be used to form the main body 62, whereby the tubular shape is accomplished by a rolling or bending of the elongate flat sheet. The main body 62 is flexible to permit a bending thereof along a longitudinal axis into arcs, curves, circles, pre-determined patterns, and other complex shapes, for example. Any conventional flexible material can be used to produce the main body 62 such as a plastic, a fabric, a lined fabric, or a reinforced flexible material, for example. The main body 62 includes a first end 66 and a spaced apart second end 68.

An outer surface of the main body 62 includes measuring indicia 70 formed thereon. The indicia 70 can include any increment, as desired. It is also understood that more than one set of indicia 70 can be provided on the tubular measuring device 60, as desired. The indicia 70 illustrated commences at the first end 66 of the main body 62 and ends at the second end 68 of the main body 62.

The main body 62 is adapted to be disposed around an elongate member 72. In the embodiment shown, the elongate member 72 is a hose, although it is understood that the elongate member 72 can be any conventional solid or tubular elongate member, as desired. The main body 62 can be adhered to the elongate member 72, or snap fit around the elongate member 72 to grip the elongate member 72, as desired. The elongate member 72 includes a first end 74 having a fitting 76 and a second end 78 having a fitting 80 disposed thereon. The fittings 76, 80 can be any conventional fitting such as a male and a female hose coupling, for example.

In use, the main body 62 of the measuring device 60 is disposed around the elongate member 72. This facilitates the conversion of a conventional elongate member 72 such as a hose, for example, into a flexible measuring device. As described previously, the main body 62 can be adhered to the elongate member 72, or snap fit around the elongate member 72 to grip the elongate member 72, as desired. The separation 64 may be present after the main body 62 is disposed around the elongate member 72. Alternatively, the separation 64 can be eliminated if desired by abutting the edges of the main body 62 forming the separation 64 against one another or by overlapping one edge over the other. Once the main body 62 of the measuring device 60 is disposed around the elongate member 72, the measuring device 60 is used as described above for the tubular measuring device 10.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A measuring device comprising:
an elongate flexible main body having a first open end, a second open end, an outer surface, and a hollow interior; and
measuring indicia disposed on at least a part of the outer surface of said main body between the first end and the second end thereof.

2. The measuring device according to claim 1, wherein said main body is opaque.

3. The measuring device according to claim 1, wherein at least a part of said main body is transparent.

4. The measuring device according to claim 1, wherein at least a part of said main body is semi-transparent.

5. The measuring device according to claim 1, wherein said main body is a hose.

6. The measuring device according to claim 1, including a fitting disposed on the first end of said main body and a fitting disposed on the second end of said main body.

7. The measuring device according to claim 1, wherein said indicia includes markings for measurement of a length.

8. The measuring device according to claim 1, wherein said indicia includes markings for measurement of a volume of fluid contained in said main body.

9. The measuring device according to claim 1, including at least two sets of measuring indicia disposed on the outer surface of said main body.

10. The measuring device according to claim 9, wherein said two sets of measuring indicia include markings for measurement of a length and markings for measurement of a volume of fluid contained in said main body.

11. A measuring device comprising:
an elongate flexible main body having a first open end, a second open end, an outer surface, and a hollow interior, wherein said main body is adapted to have an elongate member inserted therein extending from the first end to the second end of said main body; and
measuring indicia disposed on at least a part of the outer surface of said main body between the first end and the second end thereof.

12. The measuring device according to claim 11, wherein said main body is opaque.

13. The measuring device according to claim 11, wherein at least a part of said main body is transparent.

14. The measuring device according to claim 11, wherein at least a part of said main body is semi-transparent.

15. The measuring device according to claim 11, wherein the elongate member is a hose and said indicia includes markings for measurement of at least one of a length and a volume of fluid contained in the elongate member.

16. A measuring device comprising:
an elongate flexible main body having a first end, a second end, an outer surface, a hollow interior, and a separation formed in the outer surface extending from the first end to the second end, wherein said main body is adapted to have an elongate member disposed therein extending from the first end to the second end of said main body; and
measuring indicia disposed on at least a part of the outer surface of said main body between the first end and the second end thereof.

17. The measuring device according to claim 16, wherein said main body is adhered to the elongate member.

18. The measuring device according to claim 16, wherein the elongate member is a hose and said indicia includes markings for measurement of at least one of a length and a volume of fluid contained in the elongate member.

19. The measuring device according to claim 16, wherein said main body is opaque.

20. The measuring device according to claim 16, wherein at least a part of said main body is at least one of transparent and semi-transparent.
